(19) United States
(12) Patent Application Publication
(10) Pub. No.: US 2005/0283740 A1
(43) Pub. Date: Dec. 22, 2005

(54) Information organization and display

(76) Inventors: Frederick Cleeves, Scottsdale, AZ (US); Lawrence W. Smith, Seattle, WA (US)

Correspondence Address: Mark S. Peloquin;PELOQUIN, PLLC, Suite 4100, 800 Fifth Avenue, Seattle, WA, 98104-3100, US

(21) Appl. No.: 10/870,600

(22) Filed: Jun. 17, 2004

(51) Int. Cl. G06F 17/00

(52) U.S. Cl. 715/835; 715/837

(57) ABSTRACT

An apparatus includes an information content that has a unit of information. The apparatus further includes an object-icon, which has a part. The information content is logically associated with the object-icon and the unit of information is logically associated with the part. The object-icon visually resembles something of interest to a user. The apparatus further includes a storage device, which is configured to store information, such as the information content or the unit of information and an information display in communication with the storage device. The apparatus further includes a processor programmed to display the object-icon on the information display and to display the part on the information display if the object-icon is selected by the user.

### RELATED APPLICATIONS

Co-pending, commonly assigned U.S. patent application entitled “INFORMATION ORGANIZATION AND NOTIFICATION,” filed on the same day as this application, attorney docket number 011504.P001.

### BACKGROUND OF THE INVENTION

1. Field of Invention

The invention relates generally to information organization and access, and more specifically to methods and apparatuses that process and present information to a user electronically.

2. Art Background

Life in modern society is complex and is becoming increasingly more complex due to the amount of information that a person must process and respond to on a daily basis. Two areas of life produce large amounts of information that require organization and access, these areas of life include architectural structures and vehicles that people are in control over at various levels. Various levels of control include ownership, lease, shopping, etc. One example of an architectural structure is a person's home, another is a cabin, a garage, a barn, etc.

A home can include such items as a dishwasher, a microwave oven, a gas or an electric range, an air conditioning system, a heating system, hot tub, etc. all of which produce information that require an expenditure of time on the part of the person or persons involved with the items. These items usually come from the respective manufacturer with information presented in the form of a printed booklet, a video tape, a compact disk (CD), etc. Many of these items have maintenance schedules requiring service at certain points in time or have a warranty that ends at some future date. The person(s) responsible for the item(s) expends time in an effort to be cognizant of the needs of the items in order to take action within the different time intervals. Such expenditure of time requires the information to be filed for future access and requires the person(s) to remember the needs of the individual items or requires the person(s) to periodically review the file to be reminded of the item's individual needs. Such a demand on a person's time creates a multitasking burden that can create a problem.

A vehicle is another source of a large quantity of information that requires processing and action by a user. In some cases, the quantity of information can exceed that of an architectural structure. One example of a vehicle is a motor home, another example of a vehicle is a car or truck, other vehicles are boats, airplanes, etc. A vehicle comes with a variety of parts or components that can have individual maintenance schedules and warranty periods. These maintenance schedules and warranty periods require a person to file the information and then to be able to remember the important dates, so that the information can be accessed and appropriate action can be taken in a timely manner. Such expenditure of time to file, remember, access, etc., information related to architectural structures and vehicles can create a level of multitasking that stresses a person; thereby, creating a problem.

For information presented in paper form, filing information, such as described above, is presently done in some cases with a filing cabinet. Information can also be filed utilizing electronic means, such a computer system. Filing information in paper form, such as service intervals, required by items of an architectural structure or a vehicle (from an owner's manual) can be time intensive, and can occupy much more time than is reasonable considering the demands of life in modern society. Such existing methods of filing, can tax a person's ability to multitask, create mental stress, and can diminish a person's enjoyment of life, this can present a problem.

Existing programs are available to allow a user to file information, relating to an architectural structure or a vehicle, on a data processing device, such as a home computer, personal digital assistant (PDA), tablet computer, etc. A paper document can be scanned by a scanner to create an electronic file that can be filed utilizing an operating system such as one of the operating systems manufactured and sold by Microsoft, Inc. Examples of existing operating systems are WINDOWS® XP Home, WINDOWS® XP Professional, etc. Other operating systems perform similar functions and are made by other companies such as Apple Computer, Inc. In other cases, a custom document can be created by a user utilizing a word processing program such as WORD®, WORD PERFECT®, etc. Such word processing programs allow a person to, among other things; reduce the amount of information provided by the manufacturer down to an amount of information that will require action on the part of the user. The person culls the information in order to separate out those items of information that will require action at a future date. In other cases, scheduling programs exist, such as MICROSOFT® OUTLOOK, that permit a person to schedule future events that require action by the person. Such word processing and scheduling programs require input on the part of a person and can create a multitasking load that can create stress, reduce enjoyment in life, and cause an important event to be missed that required action by the person, etc. all of which can create a problem. An example of an existing user interface is shown generally in FIG. 1 at 100.

Existing user interfaces of data processing devices partition information into folders and subfolders. Such partitioning requires a person to read titles and subtitles of directories. With reference to FIG. 1, an existing user interface for a data processing system is shown generally at 100. The views presented in FIG. 1 can represent, for example, a portion of the user interface of the WINDOWS® XP HOME operating system or a program running within an environment provided by an operating system. An upper level folder containing information related to a person is indicated within a window 102. The window 102 contains folders indicated by icons 104, 106, 108, and 110. The folder 104 has a title “My House,” so named by a user to help facilitate remembering what information is in the folder. In like manner, icons 106, 108, and 110 each have titles that facilitate remembering what is in the respective folders. Selecting folder icon 104 will open the contents of the folder into a subwindow 120. Four subfolders are evident, 122, 124, 126, and 128; these subfolders are contained within folder 104. Each of the icons 122, 124, 126, and 128 has a subtitle that the user must read and think about in order to remember and understand the organization of the filing system; thereby, allowing the retrieval of information from the respective folders. Similarly, selecting subfolder icon 122 causes a further subwindow 130 to open; thereby, displaying icons 132, 134, 136, 138, 140, and 142. Each of these respective icons has a subtitle that the user must read and think about in order to remember how the information was organized and stored in the respective folders. Such an organization of information utilizing text labels for the subtitle of a folder or subfolder can create undue mental processing for the person, this can create a problem.

Current programs such as the word processing programs and scheduling programs described above require the information to be in multiple places, such as a physical paper filing cabinet, data processing device, multiple programs within a data processing device, etc. Distributing information on an architectural structure or a vehicle across multiple locations and programs can cause a person difficulty remembering where certain items of information were filed. Such difficulties can result in missing an opportunity to keep an item under warranty. For example, at times a person defers purchasing an extended warranty to a future date and misses the opportunity to purchase the warranty due to existing cumbersome methods of manually filing information stored in paper form or by using a variety of software programs together with the inefficiencies attendant upon retrieving such information handled in this manner, all of which can present a problem.

### BRIEF DESCRIPTION OF THE DRAWINGS

The invention may best be understood by referring to the following description and accompanying drawings that are used to illustrate embodiments of the invention. The invention is illustrated by way of example in the embodiments and is not limited in the figures of the accompanying drawings, in which like references indicate similar elements.

FIG. 1 illustrates an existing methodology used to access and organize information.

FIG. 2 depicts a method of processing information according to one embodiment of the invention.

FIG. 3A shows an apparatus that processes information according to one embodiment of the invention.

FIG. 3B illustrates a letter template according to one embodiment of the invention.

FIG. 3C illustrates another letter template according to one embodiment of the invention.

FIG. 3D depicts graphical display of contractor data according to one embodiment of the invention.

FIG. 4 illustrates another apparatus that processes information according to one embodiment of the invention.

FIG. 5 illustrates accessing information according to one embodiment of the invention.

FIG. 6 depicts accessing information utilizing object-icons, according to one embodiment of the invention.

FIG. 7 illustrates organizing information utilizing object-icons according to one embodiment of the invention.

FIG. 8 illustrates a method of creating a user interface according to one embodiment of the invention.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those of skill in the art to practice the invention. In other instances, well-known circuits, structures, and techniques have not been shown in detail in order not to obscure the understanding of this description. The following detailed description is, therefore, not to be taken in a limiting sense, and the scope of the invention is defined only by the appended claims.

Methods and apparatuses are disclosed that facilitate the efficient processing and access of information by a person or user. In the context of this description of embodiments of the invention, the terms user(s), person(s), etc. are intended to refer interchangeably to a living person who has “interest” and/or control over the information and/or the items associated with the information. “Interest” refers to, in one example, a person that is related to the owner of the item and/or the information or a person that is related to someone who has a level of control over the item and/or the information.

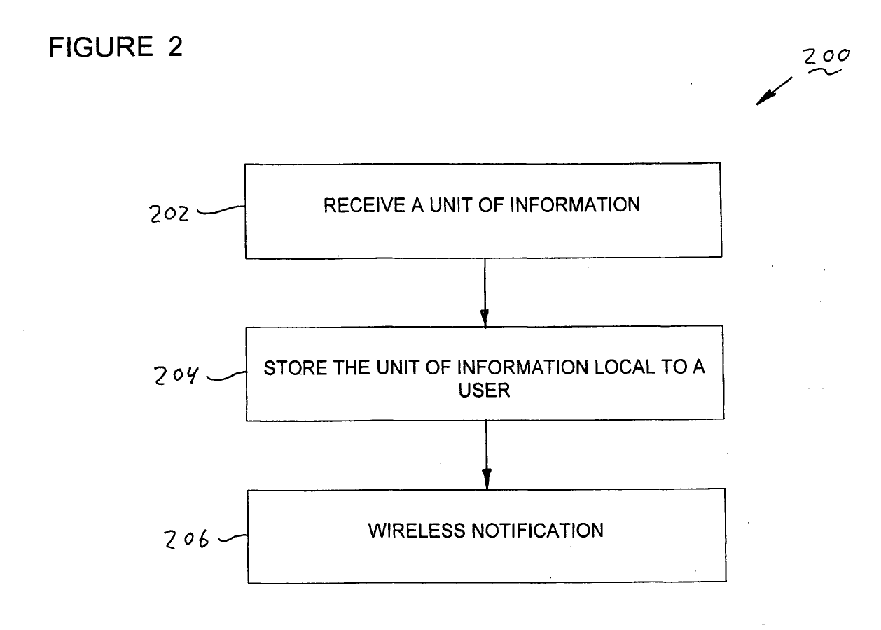

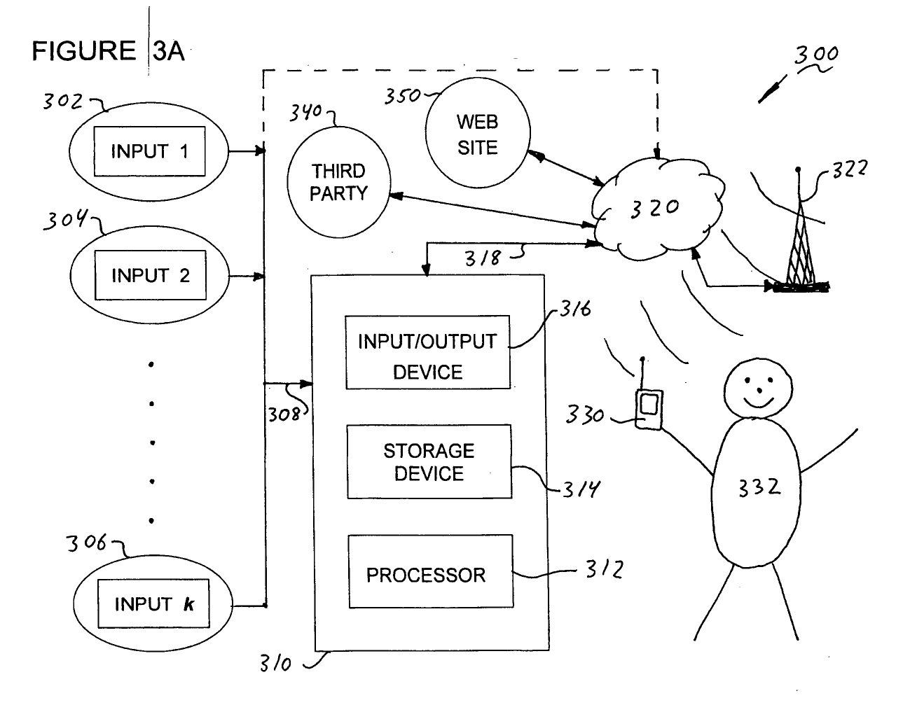

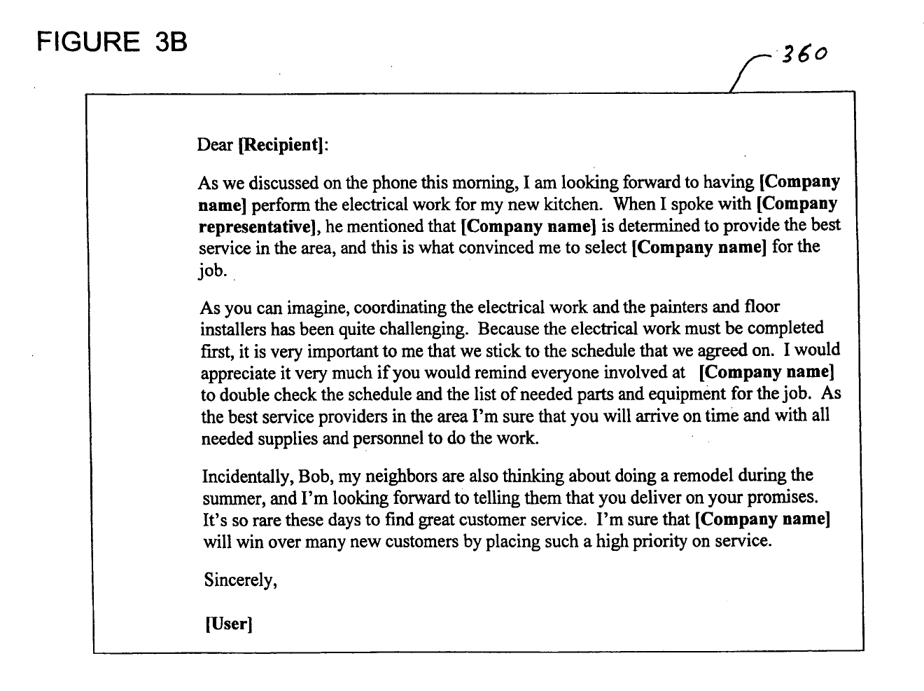

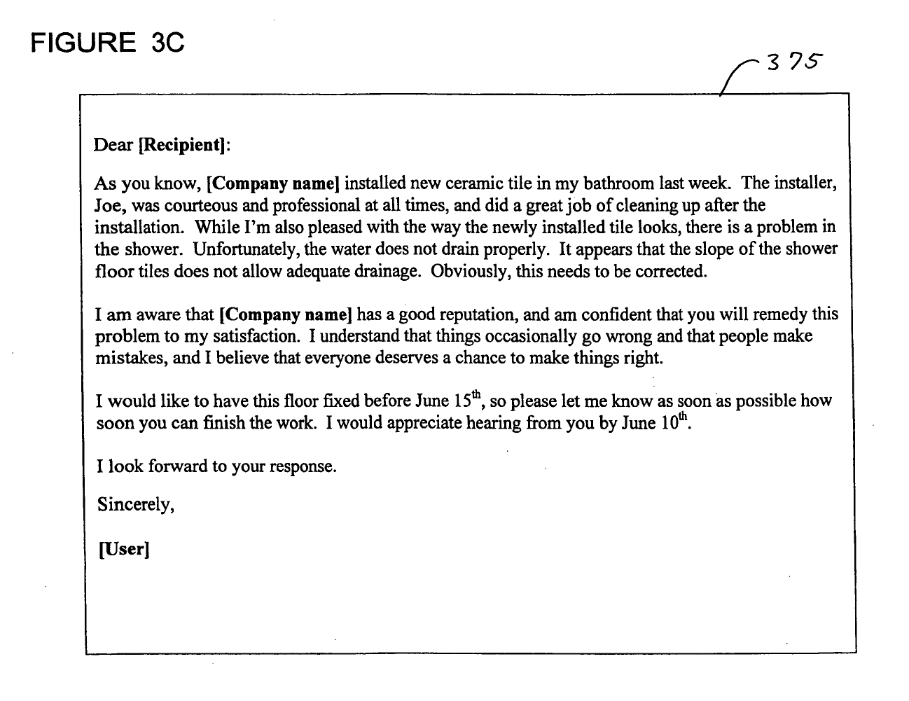

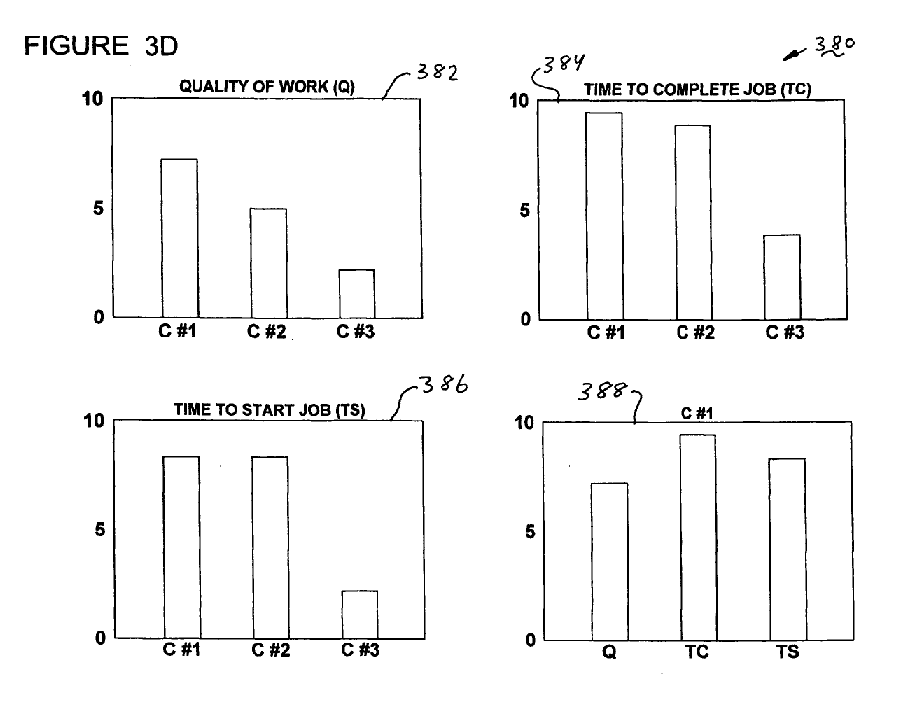

FIG. 2 depicts a method of processing information according to one embodiment of the invention. With reference to FIG. 2, a unit of information is received at block 202. The unit of information is stored local to a user at block 204. At block 206, a wireless notification is sent based on the unit of information. The wireless notification is sent, in various embodiments, to the user or to a third party. An apparatus implementing the method of FIG. 2 is illustrated in FIG. 3A.

FIG. 3A shows a system, generally at 300, that processes information according to one embodiment of the invention. With reference to FIG. 3A, a first unit of information 302, a second unit of information 304 up to a general number k 306, of units of information, are indicated as shown, being input at 308 into a device 310. The device 310 has a processor 312 with associated memory, a storage device 314 in communication with the processor 312, and an input/output device 316 in communication with the processor 312, all of which are configured to process electronic data. An application, such as a computer program designed to implement the methods taught herein; thereby performing the manipulations on the information in electronic form, is stored within the device 310, as is known to those of skill in the art. Throughout this description, reference will be made alternatively to the operation of the system, the application, the program, etc. and in all cases it will be recognized by those of skill in the art that such references are descriptive of functionality as manifest by the interaction of computer program instructions with appropriate pieces of hardware.

The units of information 302, 304, and 306 can originate from a variety of sources. For example, in one embodiment, an input comes from a manufacturer or a builder of an architectural structure such as a home, barn, garage, etc., or the manufacturer of a vehicle or a product for a vehicle. In one embodiment, the unit of information, from a builder, includes a compilation of the items installed in the architectural structure or vehicle and the pertinent service and/or warranty information. Some examples of service information are, but are not limited to, the time interval between required maintenance, such as changing/cleaning filters, flushing heating systems, cleaning boilers, cleaning chimneys, changing pool filters, etc. Some examples of warranty information are, but are not limited to, the duration of a warranty, an offer to purchase an extended warranty, a change in the organization providing service on a warranty, etc.

In one embodiment, a unit of information includes, but is not limited to, the manufacture's name, address, contact person, facsimile number, telephone number, e-mail address, and customer service telephone number. A unit of information can also include equipment information, such as but not limited to, the date of manufacture, the date of purchase, a serial number, make and model numbers, and purchase price. A unit of information can also include warranty information, such as but not limited to, warranty period, warranty start date, warranty termination date, rebate information, extended warranty options, costs, etc. A unit of information can also include retailer information, such as name, address, telephone number, facsimile number, e-mail address, and customer service number. A unit of information can also include service provider information, such as but not limited to, name, address, telephone number, facsimile number, and service provider rating.

In one or more embodiments, the units of information are in the form of electronic files that are sent to the device 310 or to the user when the user purchases an architectural structure, a vehicle or an item related thereto. For example, in one embodiment, a user purchases a new home and receives information related to items in the new home, as described above. The information can be presented to the user in a variety of ways, the information can be in the form of printed material, the information can be stored on computer readable media such a floppy disk, a CD, etc., or the information can be communicated over a network to the user. In one embodiment, the information is sent from a builder to a user over the Internet and is received at the device 310 and is stored on storage device 314 in a database. In another embodiment, the information is sent from the suppliers of devices installed in or related to the new home, vehicle, etc., to the user over the Internet and is received at the device 310 and stored accordingly. In yet other embodiments, the information is sent from different sources, e.g., partly from the builder of the home and partly from the manufactures of devices installed in or related to the home and is received by the device 310.

Some examples of architectural structures are, but are not limited to, a house, a barn, a garage, an addition, etc. Some examples of items installed in or related to an architectural structure, such as a home are, but are not limited to, appliances, entertainment devices, swimming pools, hot tubs, etc. Other items include, but are not limited to, doors, windows, roof, chimney, paint, siding, animals, garden, landscaping, fencing, sprinkler, irrigation, grass/lawn, etc. Some examples of vehicles are, but are not limited to, an automobile, a truck, a sport utility vehicle (SUV), a tractor, a lawn mower, an all terrain vehicle (ATV), a snow mobile, a motor home, a trailer, a camping trailer, or a boat. The present invention is not limited by the architectural structure, the vehicle, the item associated therewith, or the subject matter of the information input to the device 310, which is associated therewith.

Additionally, a user can input information, such as any one of the general inputs 306, to the device 310 in a variety of ways. In one embodiment, input/output 316 includes a user interface through which a user inputs information. The user interface can be configured for a variety of user inputs, such as but not limited to, accepting text input by typing, scanning, scanning with optical character recognition to convert text to an electronic data format. In another embodiment, the user provides input by speech recognition, whereby the user speaks and the device 310 converts the user's speech into an electronic format with the processor 312 in conjunction with input/output device 316 and appropriate speech recognition software. As described above, information can be input by means of a data storage media such as a disk, CD, etc. In such embodiments, input/output device 316 is configured with a reader for the appropriate data storage media.

In one or more embodiments, a user inputs information utilizing a template. Some examples of the kind of information that a template is used to input are, but are not limited to, data on an item, information for a questionnaire that reports on the performance of a service provider; quality reporting to an agency, a request for a bid, contract, etc.

Information input to the device 310 is stored on the storage device 314 to create a database that is accessed by the user using the system, and from which notifications are sent to the user at various points in time. The information within the database makes up information content that is associated with an architectural structure or a vehicle as previously described. Some examples of information stored in the database are, the information on the architectural structure or vehicle and any item associated therewith, service provider information, service provider bids, inventories of items related to an architectural structure or a vehicle, information personal to a user, schedule information, such as dates of delivery, service and maintenance pertaining to contractors, a location for the information may be held separately from the database, such as a bank safety deposit box, lawyer's office, external file, etc.

During operation of the device 310, a user or a third party is notified wirelessly, based on a unit of information. Some examples of third parties are, but are not limited to, service providers, product providers, electronic bulletin boards, governmental agencies, and consumer watchdog groups. In one embodiment, the input/output device 316 is configured to communicate wirelessly with a user 332 utilizing a connection 318 to a network 320. The network 320 utilizes a wireless network 322 to make contact with the user 332 via a mobile device 330. In this embodiment, the mobile device is configured to receive wireless communication from wireless network 322.

In one or more embodiments, the device 310 is enabled for wireless Internet communication utilizing the IEEE 802.11a, IEEE 802.11b, IEEE 802.11X, (Wi-Fi), IEEE 802.15 (WPAN) (Bluetooth) standards (originating in the United States), as well as the HiperLAN standards (originating in Europe) or other wireless communication standards that permit wireless communication by devices. In one or more embodiments, the device 310 is enabled to communicate with the user 332 via a cellular communications network. The notification sent to the user 332 can be, in various embodiments, in the form of a short text communication or an email communication. Some examples of short text communication are, but are not limited to, short message service (SMS) and instant message (IM). In one embodiment, the device 330 can be a cellular telephone equipped with text message functionality and/or Internet functionality. In another embodiment, the device 330 is enabled to receive and send email.

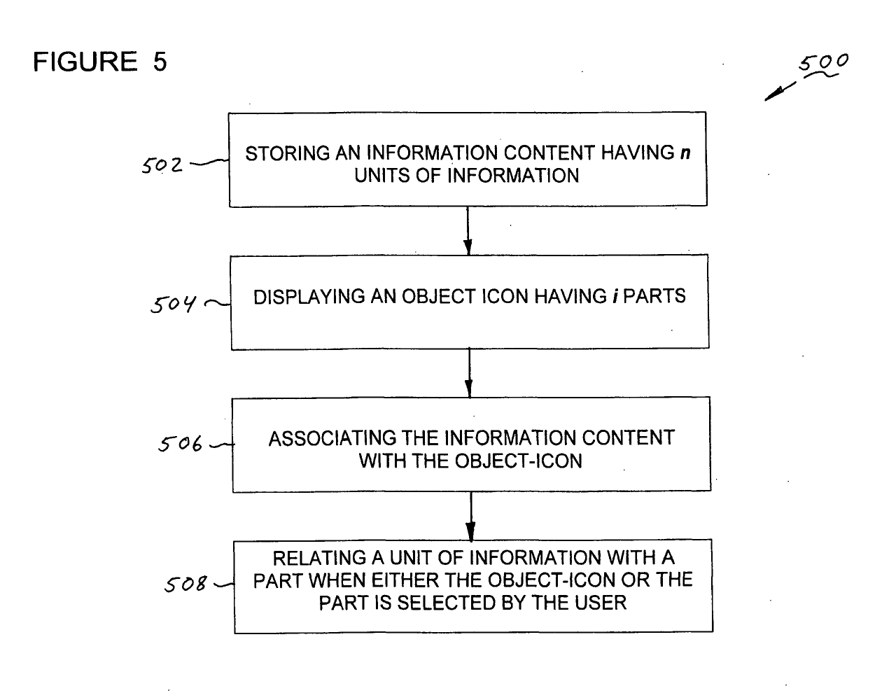

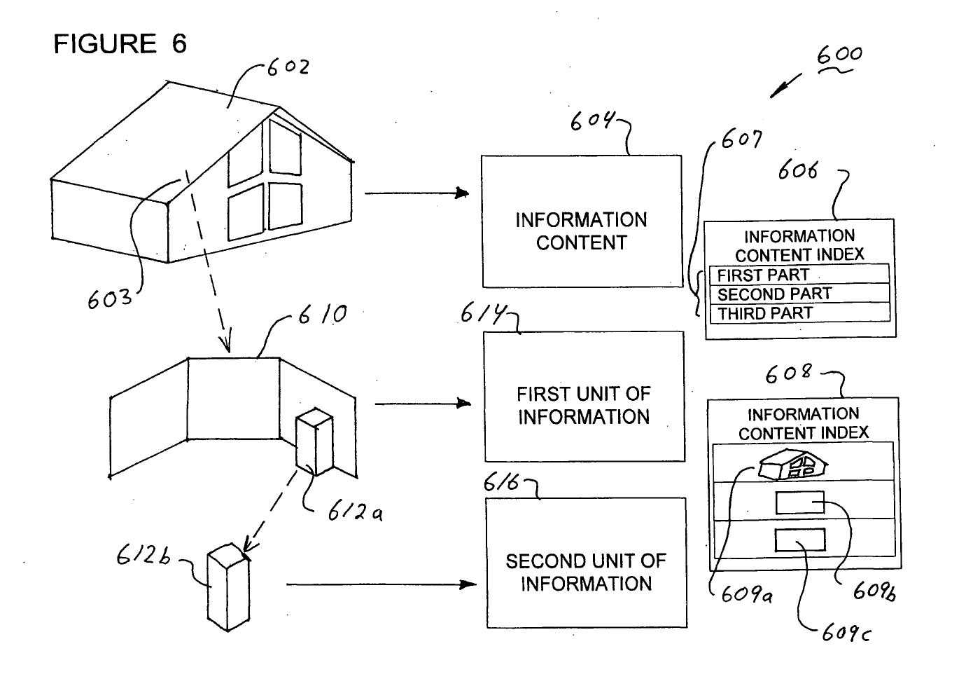

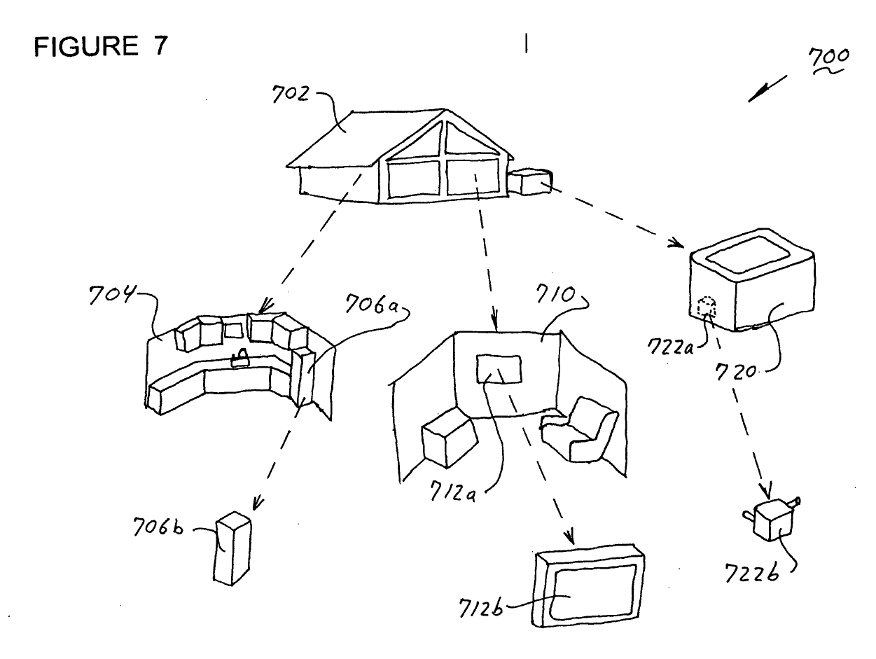

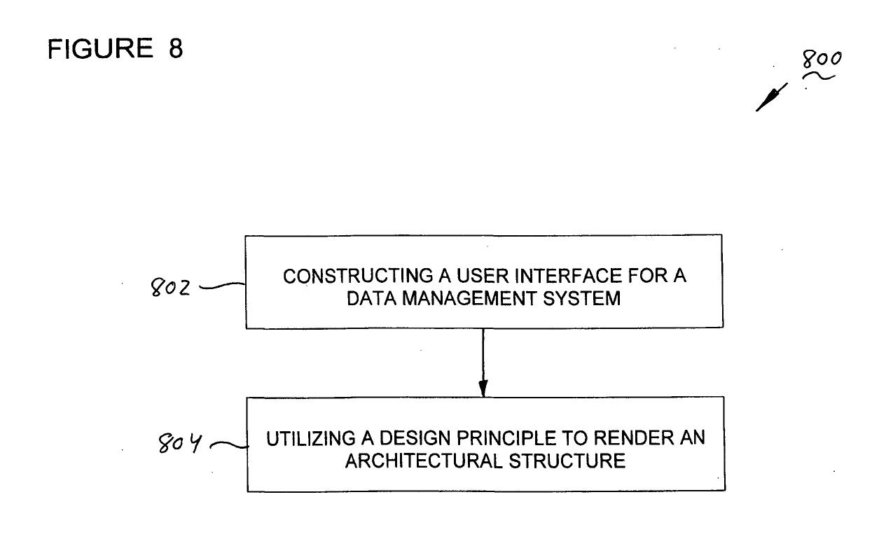

The application provides notification to the user of action that needs to be taken with respect to the architectural structure, vehicle or items related thereto, within a period of time. The period of time is flexibly adjustable and will be described below in conjunction with the figures that follow. Depending on the level of functionality of the device 330, the user has varying ability to respond to the notification. For example, in one embodiment, the device 330 will receive the notification in the form of a text message. In another embodiment, the device will permit the user to respond to the notification by taking action based on the notification, such as by sending an email or a short text message. In other embodiments, the device 330 will be equipped to allow the user to access the information content pertaining to the architectural structure or vehicle, utilizing a user interface described more fully below in conjunction with FIG. 5, FIG. 6, FIG. 7, and FIG. 8.

A variety of notifications are sent to the user 332 according to various embodiments of the invention. For example, in one embodiment, the user is sent a to-do-list. The to-do-list contains a list of actions that should be performed by the user within a given period of time. The given period of time is flexibly adjustable and will be described more fully below in conjunction with the figures that follow. The to-do-list can have a variety of related or unrelated tasks on it. For example, a user might have a remodeling project in progress on his or her home. In such a case the to-do-list might include a list of communications that need to be made in order to keep work flowing, the project on schedule, and within budget. In another example, the to-do-list could have tasks that require action by the user with respect to the home and a plurality of vehicles, or with respect to a plurality of aspects of the home. Embodiments of the present invention are not limited by the composition of a to-do-list.

In another embodiment, the user is sent an offer to purchase a product, a warranty or a service. Such an offer can be sent when an item presently under warranty is nearing the termination of its warranty period. In such a case, it is usually important to secure an extended warranty for the item before the current warranty expires. Such a situation is frequently encountered with vehicles. For example, an automobile has a factory warranty and can have an extended warranty. Utilizing the notification feature of the system, allows the user to purchase an extended warranty since the user does not have to remember to lookup the expiration date of the warranty. The notification is sent automatically based on the information input at an earlier point in time at 308 and the present date.

In the case of a vehicle, where the mileage of the vehicle is an important part of maintenance schedules, etc., in one embodiment, the mileage of the vehicle is communicated to the device 310 wirelessly by the vehicle. Such wireless communication can be performed, as is known to those of skill in the art, by enabling the vehicle for wireless Internet communication utilizing the IEEE 802.11a, IEEE 802.11b, IEEE 802.11X (Wi-Fi), and IEEE 802.15 (Bluetooth) standards (originating in the United States), as well as the HiperLAN standards (originating in Europe) or other wireless communication standards that permit wireless communication by devices. A vehicle so configured will connect with and transmit the current mileage to a data processing device when the vehicle is proximate thereto, such as when the vehicle is in the driveway of the home and can communicate with the device 310 so configured. In one embodiment, maintaining a vehicle under warranty and keeping the vehicle's maintenance schedules up to date is accomplished by the automated data gathering and automated reminder system taught herein. In another embodiment, a user periodically enters the mileage of a vehicle into the system, utilizing the mobile device 330.

In another embodiment, a vehicle's maintenance schedule is governed by hours of operation instead of miles driven. An example of such a vehicle is a tractor, a lawn mower, etc. In such a case, the vehicle is outfitted with a timer that records the hours the vehicle has operated. This information is wirelessly transmitted to the device 310 and is used to notify the user of important maintenance milestones that are required for the proper maintenance of the vehicle. In another embodiment, a user periodically enters the hours of operation of the vehicle into the system, utilizing the mobile device 330.

In one or more embodiments, a debit or a credit will be transferred in exchange for notifying the user or when the user purchases a warranty or a product in response to the notification. In one or more embodiments, a debit or a credit will be transferred in exchange for maintaining in a data base, a vendor of a warranty or a product that the user will receive notification of at a future date. An example of a debit is an invoice or a bill to show what is owed and an example of a credit is payment in the form of valuable consideration.

In one embodiment, a notification is sent to a third party, such as a service provider, notifying the service provider that an item requires service. Such a notification is sent according to the configuration of the service provider's communication system, for example, text message, email, voice mail, etc. An example of such a notification would arise in a situation where the user had setup the system to notify a service provider that a furnace needed cleaning. In one embodiment, such a notification is sent automatically to the service provider, by the system, without any action being required by the user. The service provider receives the notification and can contact the user by email, telephone, etc. if contacting the user is necessary before performing the service. In one embodiment, the service provider has information on the user that instructs the service provider as to the user's preferred method of contact. In another embodiment, the system transmits the users information to the service provider that allows the service provider to contact the user. In another example, the service provider will perform the service and notify the user that the service has been performed. In yet another embodiment, a user can choose to have a higher level of interaction with the system, such that the user is involved in the process all the way up to and including performing the service by himself or herself.

In another embodiment, a notification is sent to a third party at 340; thereby, providing feedback on the level of service provided by the service provider to the user. Some examples of third parties are, but are not limited to, a governmental agency, a watchdog group, a rating group, a rating web-site, etc.

In one embodiment, a web-site 350 provides updates to the system by means of periodic downloads of software over the communications network 320 to the device 310. The web-site is also used to post data reported by users on service providers so that a plurality of users can share and benefit by the experiences of other users. In one or more embodiments, such data contain quantitative information on a service provided, such as but not limited to, a length of time it took for a service provider to show up at a job site, a length of time it took the service provider to complete a job, a cost estimated by the service provider before commencement of the job, and an actual cost of the job upon completion by the service provider. Such reporting of information is made uniform by means of a common format which the users use to report on their experience with service providers. In one or more embodiment, templates are used to facilitate communication with parties such as, but not limited to, service providers, contractors, manufacturers, etc. as well as to report information to the data base.

FIG. 3B illustrates a letter template according to one embodiment of the invention. With reference to FIG. 3B, a letter template is shown at 360. The letter template 360 is an example of an automatically generated template that can be annotated by a user based on the particular situation at hand by inputting entries for [Recipient], [Company Name], [Company Representative], and [User]. In one embodiment, a variety of templates are provided for building projects related to a home, such as the example shown in FIG. 3B. In another embodiment, part or all of the substance of a letter template is automatically generated by the system from the information relevant to the task at issue, such as the kitchen project described in conjunction with FIG. 3B.

The tone of the communication embodied in a letter template, such as the one illustrated in FIG. 3B, is composed to communicate with the recipient in a positive way; thereby extracting maximum cooperation from the [Recipient], [Company Representative], and other individuals associated with the Company or affected by the communication. In one or more embodiments, the tone and substance of the letter are composed utilizing a set of strengths from six core virtue areas. In one embodiment, the six core virtue areas are: Wisdom and Knowledge, Courage, Love, Justice, Temperance, and Transcendence.

In one embodiment, the strengths of creativity, curiosity, open-mindedness, love of learning, and perspective are found within the virtue area of “Wisdom and Knowledge.” In one embodiment, an example of implementing the strength of “creativity” in the application is, but is not limited to, communicating to the user or others: try to think of a novel way of doing this. In one embodiment, an example of implementing the strength of “curiosity” in the application is, but is not limited to, communicating to the user or others: what do you find fascinating, or what do you feel like exploring? In one embodiment, an example of implementing the strength of “open-mindedness” in the application is, but is not limited to, communicating to the user or others: you might want to think this through and examine it from all sides. In one embodiment, an example of implementing the strength of “love of learning” in the application is, but is not limited to, communicating to the user or others: use this to systematically add to what you know. In one embodiment, an example of implementing the strength of “perspective” in the application is, but is not limited to, communicating to the user or others: take the time to make sure that this makes sense to you.

In one embodiment, the strengths of bravery, persistence, integrity, and vitality, are found within the virtue area of “Courage.” In one embodiment, an example of implementing the strength of “bravery” in the application is, but is not limited to, communicating to the user or others: bravo for acting on your convictions! In one embodiment, an example of implementing the strength of “persistence” in the application is, but is not limited to, communicating to the user or others: in spite of the obstacles you got it done. In one embodiment, an example of implementing the strength of “integrity” in the application is, but is not limited to, communicating to the user or others: since you've presented yourself in a genuine and sincere manner, you should be able to expect an honest reply. In one embodiment, an example of implementing the strength of “vitality” in the application is, but is not limited to, communicating to the user or others: getting organized might even help you feel more excited and energetic.

In one embodiment, the strengths of love, kindness, and social intelligence, are found within the virtue area of “Love.” In one embodiment, an example of implementing the strength of “love” in the application is, but is not limited to, communicating to the user or others: with the time you've saved you can spend a little more time with your loved ones. In one embodiment, an example of implementing the strength of “kindness” in the application is, but is not limited to, communicating to the user or others: as you decide which items to get rid of, you might consider donating them to one of your favorite charities. In one embodiment, an example of implementing the strength of “social intelligence” in the application is, but is not limited to, communicating to the user or others: since your contractor probably would like to maintain his good reputation, you might want to give him a chance to redeem himself.

In one embodiment, the strengths of citizenship, fairness, and leadership are found within the virtue area of “Justice.” In one embodiment, an example of implementing the strength of “citizenship” in the application is, but is not limited to, communicating to the user or others: here's how you can do your share. In one embodiment, an example of implementing the strength of “fairness” in the application is, but is not limited to, communicating to the user or others: this is how we will give [the vendor] a fair chance. In one embodiment, an example of implementing the strength of “leadership” in the application is, but is not limited to, communicating to the user or others: let's try to encourage the group to get it done without offending anyone.

In one embodiment, the strengths of forgiveness, humility, prudence, and self-regulation are found within the virtue area of “Temperance.” In one embodiment, an example of implementing the strength of “forgiveness” in the application is, but is not limited to, communicating to the user or others: would you like to give him a second chance? In one embodiment, an example of implementing the strength of “humility” in the application is, but is not limited to, communicating to the user or others: your accomplishments speak for themselves. In one embodiment, an example of implementing the strength of “prudence” in the application is, but is not limited to, communicating to the user or others: you've decided to make a careful choice now, so you'll be less likely to regret it later. In one embodiment, an example of implementing the strength of “self-regulation” in the application is, but is not limited to, communicating to the user or others: just remember that getting started with anything worthwhile takes a little discipline.

In one embodiment, the strengths of appreciation of beauty and excellence, gratitude, hope, humor, and spirituality are found within the virtue area of “Transcendence.” In one embodiment, an example of implementing the strength of “appreciation of beauty and excellence” in the application is, but is not limited to, communicating to the user or others: I'm sure they would appreciate hearing how pleased you are with their work. In one embodiment, an example of implementing the strength of “gratitude” in the application is, but is not limited to, communicating to the user or others: taking the time to express thanks and appreciation is never a waste of time. In one embodiment, an example of implementing the strength of “hope” in the application is, but is not limited to, communicating to the user or others: this program is for people who expect the best in the future and work to achieve it. In one embodiment, an example of implementing the strength of “humor” in the application is, but is not limited to, communicating to the user or others: during a remodeling project it is important to laugh-that way you won't spend all your time yelling or crying. In one embodiment, an example of implementing the strength of “spirituality” in the application is, but is not limited to, communicating to the user or others: you're the one in a position to know whether this fits for you.

The principles described above in conjunction with communicating positive affirmation to a recipient are illustrated to correct a problem in FIG. 3C. With reference to FIG. 3C, another letter template is illustrated at 375 according to one embodiment of the invention. The substance of the letter template 375 reflects the virtue areas and strengths described above to communicate to the [Recipient], that the problem needs to be corrected without presenting the communication in an explosive or offensive way.

In one embodiment, the substance of the letter template is composed from information relevant to the subject of the letter, such as the bathroom project addressed in 375. The dates contained within the text of 375, such as June 15 and June 10 can be extracted from the information that has been input by a user that is relevant to a particular project or task. The user can then edit the letter as needed before sending the letter to the [Recipient].

Templates, such as those described above in conjunction with FIG. 3B, and FIG. 3C can be generated for a variety of uses such as but not limited to, communications of praise to various parties, communications of corrective action that is required, solicitation of bids, selection of service providers, selection of contractors, etc.

In one embodiment, a service provider or a contractor is hired or selected by an evaluation. In one embodiment, an evaluation proceeds as a user is queried with a series of questions designed to ascertain a user's preference as to the characteristic that the user finds desirable in a contractor, service provider, etc. Based on the user's response to a series of questions a list of service providers, contractors, etc. are presented to the user for selection. In one embodiment, the data on a service provider or contractor can be presented to a user in graphical or other form.

FIG. 3D depicts a graphical display of contractor data according to one embodiment of the invention. With reference to FIG. 3D, graphical data on three contractors, C#1, C#2, and C#3 are presented generally at 380. Graph 382 illustrates “quality of work” (Q) for the three contractors. Graph 384 illustrates “time to complete a job” (TC) for the three contractors. Graph 386 illustrates “time to start a job” (TS) for the three contractors. Graph 388 compares “quality of work” (Q), “time to complete a job” (TC), and “time to start a job” (TS) for contractor C#1. Various other graphical displays of data are possible within the teachings presented herein, the embodiments shown within FIG. 3D are examples of the many ways that data can be presented and are not meant to limit embodiments of the invention.

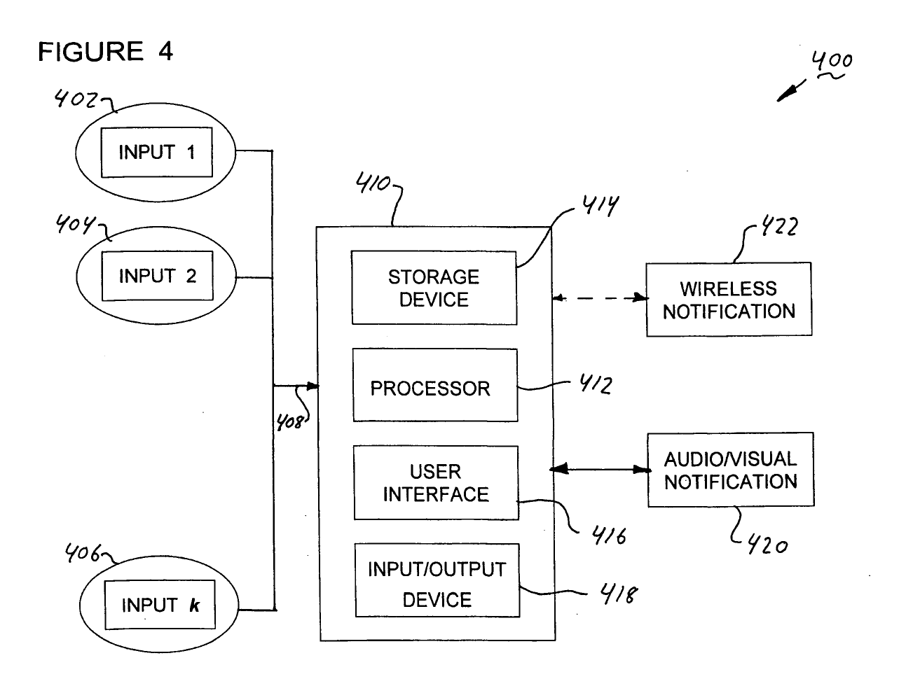

FIG. 4 illustrates another apparatus that processes information according to one embodiment of the invention. With reference to FIG. 4, a first unit of information 402, a second unit of information 404 up to a general number k at 406, of units of information, are indicated as shown, being input at 408 into a device 410. The device 410 has a processor 412 with associated memory, a storage device 414 in communication with the processor 412, an input/output 418 in communication with the processor 412, and a user interface 416, all of which are configured to process electronic data. An application such as a computer program designed to implement the methods taught herein; thereby performing the manipulations on the information in electronic form, is stored within the device 410, as is known to those of skill in the art.

The units of information 402, 404, and 406 can originate from a variety of sources as described above in conjunction with FIG. 3A. The units of information 402, 404, and 406 enjoy the same broad description as was presented for units of information 302, 304, and 306 given above in conjunction with FIG. 3A. For example, in one or more embodiments, a user inputs information utilizing a template. Some examples of the kind of information that a template is used to input are, but are not limited to, data on an item, information for a questionnaire that reports on the performance of a service provider, quality reporting to an agency, a request for a bid, contract, etc.

The units of information 402, 404, and 406 are stored on a storage device to form a data base according to the description given above in conjunction with FIG. 3A. For example, information input to the device 410 is stored on the storage device 414 to create a data base that is accessed by the user using the system, and from which notifications are sent to the user at various points in time. The information within the data base makes up an information-content that is associated with an architectural structure or a vehicle as previously described. Some examples of information stored in the data base are, the information on the architectural structure or vehicle and any item associated therewith, service provider information, service provider bids, inventories of items related to an architectural structure or a vehicle, information personal to a user, schedule information, such as dates of delivery, service, and maintenance pertaining to contractors, a location of information held separately from the data base, such as a bank safety deposit box, lawyers office, external file, etc.

The device 410 is configured with a user interface 416, with which a user can manipulate an information content containing units of information relating to an architectural structure or a vehicle (all of which were described above in conjunction with FIG. 3A). In one embodiment, the user interface includes a data display, such as a cathode ray tube (CRT), an active matrix array, a touch screen, etc. The user interface 416 is equipped, in various embodiments, with audio to augment the visual communication of information. Audio includes in some embodiments, speech recognition that allows a user to communicate with the system by speaking. The speech received by the input/output device 418 converts the user's speech into commands and electronic data that are processed by the device 410. In addition to the user interface 416, the device 410 is configured in some embodiments to provide wireless notification at 422 with a user. Such wireless notification was described above in conjunction with FIG. 3A to a user, a third party, a web site, etc.

The operation of the device 310 (FIG. 3A) and the device 410 involve, in one or more embodiments, a user interface through which a user organizes and accesses information. FIG. 5 illustrates accessing information according to one embodiment of the invention. With reference to FIG. 5, a method of organizing and accessing information is illustrated generally at 500. Information content is stored at block 502. The information content is made up of n units of information, such as the units of information 302, 304, and 306 (FIG. 3A) or 402, 404, and 406 (FIG. 4). At block 504 an object-icon is displayed, the object-icon has a number of parts i. The parts are logically associated with an object-icon. The number of units of information, n, and the number of parts, i, are limited only by the available memory of the device 310 (FIG. 3A) or 410 (FIG. 4). At block 506, the information content is associated with the object-icon. Associating, according to block 506 can result in the storage of the object-icon and the information content on the storage device 414 (FIG. 4) or the storage device 314 (FIG. 3A). At block 508, a unit of information is related with a part when either the object-icon or the part is selected by the user. Relating a unit of information with a part, at block 508, can result in presenting the part and the unit of information to a user on a user interface, such as the user interface 416 or a user interface incorporated into the device 330 (FIG. 3A). The parts of the object-icon form a hierarchical tree, such that a part has a number of subparts, and a subpart can have a number of subparts. Alternatively, the hierarchical tree can be described as an object-icon followed by a first part, and the first part is followed by a second part, etc. as the tree is descended. In this alternative description, it will be observed that the term “first part” is equivalent to part, as previously used, and the term “second part” is equivalent to “subpart,” as previously used. The descriptions are equivalent and no limitation is implied by the use of one over the other. Graphical representation of the foregoing hierarchical tree is described more fully below in conjunction with FIG. 6 and FIG. 7.

The object-icon visually resembles something of interest to the user, such as an architectural structure or a vehicle. In one embodiment, an object-icon visually resembles a house and a corresponding part visually resembles a room of the house, such as a kitchen, living room, den, library, etc. Each part (representing a room in the case of an object-icon resembling a house) can have a number of subparts; the subparts represent items located in the room. A part can have one or more units of information associated therewith or a part can serve as a place holder for subparts that have one or more units of information associated therewith. For example, in one embodiment, an object-icon represents a house; three parts exist at the first level and represent a kitchen, a bathroom, and a garage of the house respectively. All parts are located one level below the object-icon in the hierarchy. At the second level, the kitchen has a second part resembling a refrigerator. The refrigerator has one or more units of information associated therewith. In one embodiment, a first unit of information is the information that came from the manufacturer, which includes warranty information, service representative information, etc. No information exists yet at the kitchen level; therefore, in this example, the kitchen serves as a place holder that facilitates the user's ability to rapidly navigate the organizational structure of the information content in order to retrieve particular information of interest. A kitchen can have units of information associated with it once an action occurs that causes the system to create an association of units of information with the “kitchen” part. Such an action is, in one example, a kitchen remodeling project, where the kitchen is measured and pertinent information such as floor area, wall surface area, etc. are measured and entered; thereby creating an entry associated with the “kitchen” part.

In one embodiment, an organization of units of information is created with a series of parts depending from an object-icon. Examples of object-icons, representing architectural structures are, but are not limited to, a house, a barn, a building, a garage, etc. Some examples of object-icons representing a vehicle are, but are not limited to, an automobile, a truck, a sport utility vehicle (SUV), a tractor, a lawnmower, an all terrain vehicle (ATV), a snow mobile, a motor home, a camping trailer, or a boat. Object-icons can resemble any object that can be represented by an architectural structure or a vehicle, as have been described in conjunction with the figures above.

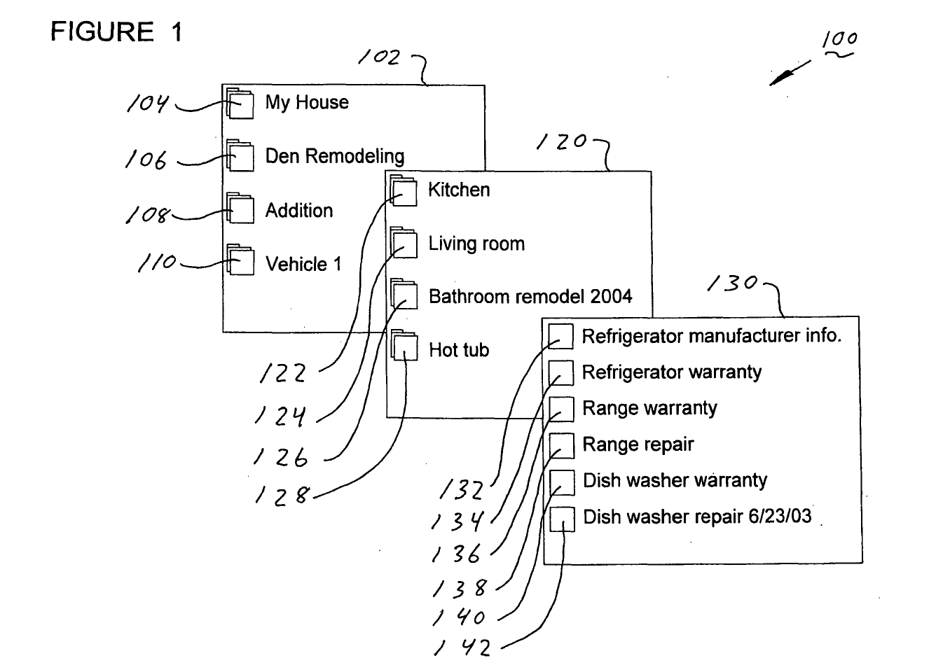

The organization of information, utilizing object-icons having a series of parts logically associated therewith and resembling other objects associated with the object-icon, utilizes a user's memory of the real life hierarchy that exists with the actual object that the object-icon resembles. The user's memory of the hierarchy associated with the object-icon can be established due to a long standing pattern of use or the object-icon and the associated hierarchy can be a newly acquired architectural structure or vehicle. The user becomes familiar with such an icon based hierarchical filing system more readily than existing filing systems utilizing text based labeling, such as the existing system shown in FIG. 1.

FIG. 6 depicts accessing information utilizing object-icons, according to one embodiment of the invention. With respect to FIG. 6, a hierarchical arrangement of information is shown generally at 600. In one embodiment, an object-icon is shown at 602 resembling a house. As described above, an object-icon can have any number of parts. In the example of FIG. 6, a first part is shown at 610; the first part 610 resembles a kitchen which represents the kitchen of the object-icon 602. Within the first part 610 is a second part 612a the second part 612a represents a refrigerator. Information can be associated with any level in the hierarchy, beginning with the object-icon and descending down to the second part 612a, as illustrated in the example, and to levels even further down the hierarchy that are not shown.

An information content associated with the object-icon 602 is represented at 604. A first unit of information 614 is associated with the first part 610. There can be any number of units of information associated with the first part 610; however, for simplicity in presentation, only one unit, 614, is displayed. A second unit of information 616 is associated with the second part 612a or 612b. When the second part is shown in its location relative to the first part 610, designation 612a is used. Referring to the same item (refrigerator) for discussion herein, designation 612b is used for the refrigerator when the refrigerator is shown by itself at the next level down the tree.

In one embodiment, the object-icon is presented with a translucent appearance, such that the user can see through the walls; thereby, observing the division of parts therein. Units of information from the information content are accessed by traversing the file system. Traversing the file system can be accomplished in a variety of ways according to embodiments of the invention. In one embodiment, a user selects a first part of the object-icon causing the first part to be displayed separately from the object-icon, as at 610. Arrow 603 indicates the position that first part 610 occupies within object-icon 602. Similarly, the second part 612a can be selected by the user, which causes the second part 612a to be displayed separately from the first part 610 as shown at 612b.

Selecting a part can be performed in a variety of ways. In one embodiment, a pointing device, such as a mouse, a stylus, etc. is directed to the location within the object-icon where the part is found and the part is selected by clicking the mouse, tapping a stylus, etc. In another embodiment, utilizing a speech enabled application, the user calls out a short phrase such as, “kitchen,” “go to kitchen,” “open kitchen,” etc., the application responds by displaying 610, for example, on an information display. Similarly, the refrigerator can be launched or separated from the first part by selecting it.

The user displays information associated with a given part (first part, second part, etc.) by selecting information to be displayed. Selecting information to be displayed can be accomplished in a variety of ways. In one embodiment, a user hovers a pointing device over an object-icon, first part, etc. and selects information, causing the information associated with the selected part to be displayed for the user. In one embodiment, a user selects a part by right clicking a mouse over the part; thereby, causing an information content to be displayed, such as an information content 604. An index to the information content 604 or an index to the information included in a part (information index) can be displayed to the user by dragging right, with a mouse, to reveal a panel 606, on which units of information are arranged at 607 with text labels. Alternatively, an information index can be displayed as shown in 608, where descriptive icon 609a represents information associated with the object-icon 602, descriptive icon 609b represents information associated with the first part 610, and descriptive icon 609c represents information associated with the second part 612b.

Selecting any one of 607, 609a, 609b, or 609c displays the units of information contained therein. The units of information are displayed as text files, audio files, video files, etc., according to the format of the unit of information.

In various embodiments, the application is speech enabled, such that selecting and/or displaying object-icons, parts, information indices, etc. are accomplished by speech commands. Some examples of speech commands are “display index,” “display house index,” “display kitchen index,” “display kitchen part,” “display kitchen information,” “display refrigerator information,” etc.

In one embodiment, operation of the application is commenced with an animated figure, which can represent the user or some other person, character, etc. standing in front of the object-icon 602. In a speech enabled application, the animated figure is directed by the commands of a user, such as, “look in the kitchen,” or “back out the car.” Upon issuing such a command, the “kitchen” part 610 is opened as indicated by arrow 603 or a garage (not shown) is entered by the animated figure. In another embodiment, the animated figure appears when the application commences and enters the object-icon 602 to commence the navigation of the filing system. In another embodiment, when information concerning a vehicle has been selected, the animated figure opens a garage, the vehicle backs out, and the information content is available to be perused by the user.

In one embodiment, an inventory of items associated with an architectural structure or a vehicle is available to a user through the user interface by selecting an object-icon, part or subpart, such as 612a. In this example, a user selects 612a and then selects inventory, the results of a search of a data base provide a list of items in inventory for 612a. In various embodiments, 612a could represent a central air conditioning unit for a house and air filters could be the items in the inventory that the application returns from a search of the data base. If no items are found in the inventory, the user is informed accordingly. In another embodiment, minimum inventory requirements can be specified by a user and as the inventory falls below the minimum requirements, the user is notified of the need to purchase items to replenish the inventory. In other embodiments, the system will issue notifications to suppliers that purchase items for inventory automatically, without action being required from the user.

Notification of a user and third parties is undertaken in ways that are designed to generate a positive psychological experience and response in the recipient of the notification. Through the use of visual and audio stimuli, a person's mind is stimulated in a positive way. In one embodiment, such positive psychological experience and response is obtained by notifications that are designed to prevent an offensive response within the user. In one embodiment, within the view presented in FIG. 6, a notification is communicated to a user when an item, represented by a first part, second part, etc. or the object-icon itself requires an action by the user or by a third party. For example, in one embodiment, if a roof of the house has reached its life expectancy, the roof will begin to turn to a different color, from its usual color, to subtly indicate that a repair should be undertaken by the user. In various embodiments, turning color can be slight at first and then will become more enhanced with the passage of time if the user does not take action to initiate a repair or replacement of the roof. Alternatively, the roof can blink or glow, first at a low frequency, so as not to offend the user, but to communicate a gentle reminder to the user that action is required. The frequency of blinking can increase if action is not taken to heighten the level of notification being communicated to the user. In another embodiment, the roof will start to slowly decay. If no action is taken, ultimately the roof (referring to object-icon 602) will disappear from view, communicating to the user what will happen if no action is taken. If the user so desires, the user can disable the notification so that the warning terminates.

Another example of a notification communicated to the user through the user interface utilizes, in one embodiment, color to communicate a notification and a sense or progress and ultimately accomplishment of a task. A first part 610 can represent a utility room and a second part 612a can represent a furnace. At the appropriate time of the year, fall in New England in one example, a notification is issued to the user that the furnace needs cleaning. The notification can be communicated by blinking the color of the furnace, changing the color of the furnace to red, etc. Alternatively, if cleaning the furnace is a maintenance item that is set for automatic attention, the system will initiate a notification to the appropriate third party, as described above in conjunction with the preceding figures, to schedule and arrange service for the furnace (sending a notification to the user as desired). Once service has been requested, the furnace will change color to indicate awaiting service. After the service is rendered, the color of the furnace will turn to a color selected to indicate that a maintenance item has been performed and completed, such as green. Such a progression of color communicates progress of a task and a sense of congratulations to the user that encourages the user in the use of the system.

In one embodiment, four colors designate four states of a maintenance cycle for an item; light red indicates that a maintenance period is approaching (the duration of display of the item as light red is variable and described below), red indicates that maintenance is currently required (but not in progress), brown indicates that the maintenance is in progress, and green indicates that the maintenance is completed. Following completion, the item is displayed as green; however, the duration of the time following completion that the item is displayed as green, is selected to keep habituation of pleasure at bay. For example, in one embodiment, the item is displayed as green for three days during which the application is used at least once, which is just enough time to create a positive psychological experience in a user, without habituating the pleasure induced thereby. Other numbers of colors are used in other embodiments of the invention. The present invention is not limited by the number of colors used to communicate the stages of the life cycle of a project.

In another embodiment, a mechanism for inducing pleasure for a user following the successful completion of a task, project, etc., is to display of a video clip on a part that was the focus of a task, such as 612a. For example, a particular user likes beaches in Hawaii; therefore, in the example of the furnace above, a video clip of a portion of a scene from a beach in Hawaii is displayed on 612a following completion of the maintenance on the furnace. As the user peruses the information content, after the maintenance item has been completed, the user can select 612a, which opens a window and displays the beach video clip. As before, to prevent habituation of pleasure, the video clip is only available for a period of time following the completion of the task.

In another embodiment, audio can be used to provide a sense of accomplishment following the successful completion of a task. In one example, a user's favorite tune or song is played for a period of time. As described above the frequency and duration that the song is played is selected to keep habituation of pleasure at bay. In one embodiment, a song is played for approximately 10 (ten) to 15 (fifteen) seconds. In yet another embodiment, a “letter of congratulations” is printed on a user's printer following the successful completion of a task. In yet another embodiment, “an award” is printed on the printer or is communicated to the user via another communication channel, such as email, etc.

FIG. 7 illustrates organizing information utilizing object-icons according to one embodiment of the invention. With reference to FIG. 7, an information display presenting the hierarchical tree, including an object-icon and related parts shown generally at 700, provides a user with a graphical picture of the information content relating to an architectural structure or a vehicle. The same type of exploded view is presented for a vehicle (not shown) in other embodiments. Utilizing the alternative description of parts and subparts, an object-icon 702 has three parts 704, 710, and 720. The part 704 represents a kitchen, the part 710 represents a living room, and the part 720 represents a hot tub. Each part has one or more subparts. For example, a subpart 706a (representing a refrigerator in one example) is a subpart of part 704. A subpart 712a (representing a television in one example) is a subpart of part 710. A subpart 722a (representing a pump) is a subpart of part 720, etc. In various views, the application will display the hierarchical relationship between object-icon, parts, subparts, etc. to provide notification to the user of items that need action by the user or of items that are presently enjoying service, maintenance, etc.

In one embodiment, the application displays the status of all items associated with the object-icon. In a mode of operation utilizing color to indicate the status of an item, the items are displayed in a color appropriate to communicate the status of the item, such as light red, red, brown, green or another color scheme. Alternatively, in embodiments, employing other forms of notification, items will blink to indicate their status. In various embodiments, when a task is complete, such as the completion of a repair on television 712a, a video clip plays on the item to communicate a sense of congratulations to the user or another type positive affirmation is directed to the user. Positive affirmations can be directed to the user in a variety of ways, such as but not limited to, a video, audio, text, etc.

In various embodiments, the application is designed to reinforce the effectiveness of positive affirmations or “events” (sounds, visual displays, printed materials, etc.). In one embodiment, the principle of “Contingency” is used to maximize the effectiveness of an “event” by delivering the “event” after a desired behavior occurs but not when an undesirable behavior occurs. In another embodiment, the principle of “Immediacy” is used to deliver an “event” proximate to the occurrence of the desirable behavior. One example of the principle of “Immediacy” is utilizing a communication channel selected to accomplish delivery of the “event” within predefined delivery parameters. For example, email might be selected over printing a “congratulatory” message if a user is not proximate to a printer. The location of the user can be estimated from the source of the user's interaction with the system. In some embodiments, when a user is communicating with the system, utilizing a device that has global positioning system functionality, the user's position can be determined more precisely and an appropriate communication channel can be selected through which the “event” is communicated to the user. In another embodiment, a user can be determined to be located at a home computer collocated with a printer when the user communicates with the system via an input device proximate to the printer, such as a keyboard. In another embodiment, the principles of “Size” and “Satiation/Deprivation” are used to produce a favorable reinforcement of behavior within a user. For example, the principle of “Size” states that the more of an “event” that is delivered the greater is the effect on the desirable behavior. However, the principle of “Satiation/Deprivation” is considered in conjunction with “Size” to prevent the habituation of pleasure as described above. The foregoing principles are utilized to increase the effectiveness of the “events” on the desirable behavior of a user.

As described above, the subpart 706a can be selected by a user causing the subpart 706a to be displayed as 706b. Similarly, the subpart 712a can be selected and can be displayed separately from part 710 as subpart 712b and subpart 722a can be selected; thereby causing it to be displayed separately from its part 720 as subpart 722b.

Incorporated into the application, in various embodiments, is the ability to customize the application for a skill level of a given user. The application can be made more difficult by increasing the time-window over which the application “looks-ahead” to provide notification to a user of pending maintenance for an item. The user can adjust this time-window to be as wide or narrow as is desired, within the limits of logic. For example, one user might choose a 30 (thirty) day look-ahead period, while another user might choose a 5 (five) day look-ahead period, while yet another user might choose a 6 (six) month look-ahead period. Look-ahead periods can be set individually for items separately or look-ahead periods can be made uniform across all items.

In one embodiment, upcoming items can be displayed on a calendar for a given time-window, for example 30 (thirty) days. In this example, all of the items that are scheduled in the next thirty day period are displayed on the calendar for the user to view. In one embodiment, the calendared items can not be removed or deactivated until completed; these items must be attended to by the user, such as mandatory service on a car, etc. In another embodiment, the calendared items can be deactivated by a user.

In one embodiment, the calendared items are presented as icons on a calendar that cover a time-window, such as a day, a week, a month, a year, etc. The icons presented on the calendar are related to the object-icon or part as described above. In one embodiment, selecting an icon on the calendar will open up the information associated with that icon.

Another level of customization and difficulty resides in the way a user configures the application to respond to maintenance or tasks for individual items. For example, a user who wants to be challenged by the application might want to receive notification before any third party is contacted; thereby, giving the user total control over the tasks. Another user might choose to receive a minimum amount of notification, such that the third parties receive the maximum notification and control. In other embodiments, the application can be configured at intermediate settings of complexity as desired.

The application also provides a user with the ability to customize the appearance of the object-icon to resemble the user's own architectural structure or vehicle or the user can select from a set of predefined architectural structures or vehicles. For example, some examples of architectural structures that the user can select from are, but are not limited to, a New York City style loft, a ski cabin, a beach house, etc. A vehicle such as an automobile can be selected from a list of templates that includes, but is not limited to, a Ferrari®, a Rolls Royce®, a Jaguar®, a Corvette®, a Viper®, a Bentley®, a Mazzarrati®, a Lexus®, a Mustang®, a BMW®, etc.

In one embodiment, the application provides a user with an environment with which the user can design a “dream home,” undertake a remodeling project, etc. The application creates representations of architectural structures by employing principals that are predisposed to generate a positive psychological response in a user. FIG. 8 illustrates a method of creating a user interface according to one embodiment of the invention. With reference to FIG. 8, a method is illustrated generally at 800. At block 802 a user interface for a data management system is constructed. At block 804 an architectural structure is rendered utilizing one or more design principles selected to produce a positive emotional reaction in the mind of a user who views the rendering.

In one embodiment, a design principle creates a main entrance for a building by placing the main entrance at a point where it can be seen immediately from a viewing perspective. The main entrance is also imbued with a bold visible shape which stands out in front of the building.

In one embodiment, a design principle places a vehicle parking space and a main entrance to a house in such a relation to each other that the shortest route from the parked vehicle to both, the kitchen and the living room, is always through the main entrance of the house. The parking space is placed such that the place where the car stands is perceived to be a room, not just a gap in the terrain adjacent to the house.

In one embodiment, a design principle creates an entrance room for an architectural structure which is light filled, the room marks and straddles the boundary between indoors and outdoors. The room covers some space outdoors and some space indoors. In one embodiment, the part outside is similar to a porch and the inside portion is similar to a hall or sitting room.

In one embodiment, a design principle creates a kitchen for a house that is lager than usual. The kitchen is large enough to function as a family room. The kitchen is placed near the center of a common area of the house, not as far back as an ordinary kitchen. The kitchen is large enough to hold a large table and chairs, some soft and others hard, with counters, stove, and sink around the edges of the room.

In one embodiment, a design principle for a room places a source of outdoor light on at least two adjacent walls of the room.

In one embodiment, a design principle for situating fire in a structure places the fireplace in a common area of the structure such as a kitchen, where the fire provides a natural focus for communication, evoking dreams and deep discussion between people. Adjacent rooms are adjusted so that a view from each room catches a glimpse of the fire.

In one embodiment, a design principle for a structure creates an eating atmosphere by placing a heavy table in the center of the eating space, which is large enough for the whole family or group to use. The space is enclosed with walls or contrasting darkness with light emanating from the middle of the eating space.

In one embodiment, a design principle creates a cooking layout for an architectural structure by balancing the distribution of stove, sink, food storage, and counter such that no two of the four are more than 10 (ten) feet apart, the total length of the counter, excluding sink, stove, and refrigerator is at least 12 (twelve) feet, and no one section of the counter is less than 4 (four) feet long.

In one embodiment, a design principle varies the intimacy of a space (room) by varying the ceiling heights in rooms of an architectural structure. In one embodiment, two rooms that open into each other each have ceilings of different height. In one embodiment, ceilings are high in public rooms (10 (ten) to 12 (twelve) feet), or rooms meant for large gatherings, and ceilings are lower (7 (seven) to 9 (nine) feet) in rooms that are meant for small gatherings, and very low (6 (six) to 7(seven) feet) in rooms or alcoves meant for one or two people.

In one embodiment, a design principle places a window such that a view from the window affords the best possible view out over the surrounding terrain.

In one embodiment, a design principle differentiates a view by placing a window in an architectural structure that affords a view that is markedly different from the view of the indoor space.

In one embodiment, a design principle locates a door into a room of an architectural structure by placing the door away from the middle of a wall of the room. In one embodiment, a door is placed near the corners of a smaller room. In one embodiment, a door is placed near the center of a wall of a larger room. In another embodiment, when a room has doors that connect into two adjacent rooms, the doors are placed near a corner of the room.

In one embodiment, a design principle for texturing a wall of an architectural structure creates a thick wall and then varies the thickness of the wall.

In one embodiment, a design principle for varying window size in an architectural structure makes each window a different size according to its place in the structure. In one embodiment, the size of the windows decreases with increasing elevation through the structure.

In one embodiment, a design principle for configuring window operation in an architectural structure provides for a window to swing open wide; thereby exposing the indoors to the outdoors.

In one embodiment, a design principle for configuring a window partitions a window into smaller panes of glass.

In one embodiment, a design principle creates a private domain associated with a structure by placing a bench outside of a front door. In another embodiment, a private domain is created by utilizing a low wall, a tree, or a shrub.

In one embodiment, a design principle positions flowers around a structure to soften the edges of the structure. In one embodiment, flowers are positioned in raised beds around the architectural structure.

In one embodiment, a design principle positions paving stones around an architectural structure with spaces in between the stones and grass or flowers interspersed in the spaces.

In one embodiment, a design principle creates pools of light within an architectural structure by demarcating light and dark areas with light and the absence of light.

One or more of the foregoing list of design principles are utilized in various embodiments, to render an architectural structure, such as object-icon 602 (FIG. 6) and object-icon 702 (FIG. 7). Architectural structures so rendered generate a positive mental response in the viewer of the rendering, which enhances a user's enjoyment of the application.

For purposes of discussing and understanding the embodiments of the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.), etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

While the invention has been described in terms of several embodiments, those of skill in the art will recognize that the invention is not limited to the embodiments described, but can be practiced with modification and alteration within the spirit and scope of the appended claims. The description is thus to be regarded as illustrative instead of limiting.

1. An apparatus comprising:
an information content, the information content having a unit of information;
an object-icon, the object-icon having a part, wherein the information content is logically associated with the object-icon and the unit of information is logically associated with the part and the object-icon visually resembles something of interest to a user;
a storage device, the storage device is configured to store information, wherein information is the information content or the unit of information; and
an information display in communication with the storage device;
a processor programmed to:
display the object-icon on the information display;
display the part on the information display if the object-icon is selected by the user.

2. The apparatus of claim 1, wherein the object-icon represents something owned by, or related to, the user.

3. The apparatus of claim 1, wherein the information content can be accessed by manipulating the object-icon.

4. The apparatus of claim 3, wherein manipulating is selecting or hovering a pointing device over the object-icon.

5. The apparatus of claim 1, wherein the unit of information can be accessed by manipulating the part.

6. The apparatus of claim 5, wherein manipulating is selecting or hovering a pointing device over the object-icon.

7. The apparatus of claim 1, wherein the object-icon is an architectural structure or a vehicle.

8. The apparatus of claim 7, wherein the vehicle is an automobile, a truck, a sport utility vehicle (SUV), a tractor, a lawnmower, an all terrain vehicle (ATV), a snow mobile, a motor home, a trailer, a camping trailer or a boat.

9. The apparatus of claim 1, wherein the architectural structure is a home, a barn, a garage, an addition or a building.

10. The apparatus of claim 1, wherein the processor is further programmed to display a representation of an architectural structure on the information display and the architectural structure is designed utilizing a principle selected from the group consisting of a means for configuring a main entrance, a means for placing a vehicle parking space, a means for creating an entrance room, a means for configuring a kitchen, a means for providing outside light to a room, a means for situating a fire within the architectural structure, a means for creating an eating atmosphere, a means for creating a cooking layout, a means for varying the intimacy of a space, a means for sizing a window area, a means for differentiating a view, a means for locating a door to a room, a means for creating texture within a wall, a means for varying window size, a means for configuring window operation, a means for configuring a door, a means for configuring a window, a means for creating a private domain associated with the architectural structure, a means for positioning flowers, a means for positioning paving stones, and a means for creating a pool of light.

11. The apparatus of claim 1, wherein information is presented to the user in a calendar format.

12. The apparatus of claim 11, wherein the information is presented as an icon.

13. An apparatus comprising:
an information content having a general number (n) of units of information;
a first unit of information, the first unit of information is one of the general number (n) of units of information;
a second unit of information, the second unit of information is one of the general number (n) of units of information;
an object-icon having a general number (i) of parts, the information content is logically associated with the object-icon and the object-icon visually resembles something of interest to a user;
a first part, the first part is one of the general number (i) of parts;
a second part, the second part is one of the general number (i) of parts; wherein the first unit of information is associated with the first part and the second unit of information is associated with the second part;
a storage device, the storage device is configured to store information, wherein information is the information content, the first unit of information, the second unit of information, the object-icon, the first part or the second part;
an information display, in communication with the storage device; and
a processor programmed to:
display the object-icon on the information display;
display the first-part on the information display if the object-icon is selected by the user;
display the second-part on the information display if the object-icon is selected by the user or the first-part is selected by the user.

14. The apparatus of claim 13, wherein the information content is related to an architectural structure or a vehicle owned by the user.

15. The apparatus of claim 14, wherein the vehicle is an automobile, a truck, a sport utility vehicle (SUV), a tractor, a lawnmower, an all terrain vehicle (ATV), a snow mobile, a motor home, a trailer, a camping trailer, or a boat.

16. The apparatus of claim 13, wherein the architectural structure is a home, a barn, a garage, an addition or a building.

17. The apparatus of claim 13, wherein the information content can be accessed by manipulating the object-icon.

18. The apparatus of claim 17, wherein manipulating is selecting or hovering a pointing device over the object-icon.

19. The apparatus of claim 13, wherein the first unit of information can be accessed by manipulating the first part.

20. The apparatus of claim 19, wherein manipulating is selecting or hovering a pointing device over the object-icon.

21. The apparatus of claim 13, wherein the second unit of information can be accessed by manipulating the second part.

22. The apparatus of claim 21, wherein manipulating is selecting or hovering a pointing device over the object-icon.

23. The apparatus of claim 13, wherein a unit of information can be accessed from an information content index.

24. The apparatus of claim 13, wherein the object-icon is an architectural structure or a vehicle.

25. The apparatus of claim 24, wherein the vehicle is an automobile, a truck, a sport utility vehicle (SUV), a tractor, a lawnmower, an all terrain vehicle (ATV), a snow mobile, a motor home, a trailer, a camping trailer or a boat.

26. The apparatus of claim 13, wherein the processor is further programmed to display a representation of an architectural structure on the information display and the architectural structure is designed utilizing a principle selected from the group consisting of a means for configuring a main entrance, a means for placing a vehicle parking space, a means for creating an entrance room, a means for configuring a kitchen, a means for providing outside light to a room, a means for situating a fire within the architectural structure, a means for creating an eating atmosphere, a means for creating a cooking layout, a means for varying the intimacy of a space, a means for sizing a window area, a means for differentiating a view, a means for locating a door to a room, a means for creating texture within a wall, a means for varying window size, a means for configuring window operation, a means for configuring a door, a means for configuring a window, a means for creating a private domain associated with the architectural structure, a means for positioning flowers, a means for positioning paving stones, and a means for creating a pool of light.

27. The apparatus of claim 13, wherein information is presented to the user in a calendar format.

28. The apparatus of claim 27, wherein the information is presented as an icon.

29. A method comprising:
displaying an object-icon on an information display, wherein the object-icon visually resembles something of interest to a user;
associating an information content with the object-icon, such that when the object-icon is selected, the information content is accessible to the user; and
relating a first part of the object-icon with a first unit of information, wherein the first unit of information is part of the information content.

30. The method of claim 29, further comprising:
selecting the first part, wherein the selecting makes the first unit of information accessible to the user.

31. The method of claim 29, further comprising:
selecting a second part of the object-icon, wherein the selecting makes a second unit of information accessible to the user and the second unit of information is part of the information content.

32. The method of claim 29, wherein the information content is related to an architectural structure or a vehicle owned by the user.

33. The method of claim 32, wherein the vehicle is an automobile, a truck, a sport utility vehicle (SUV), a tractor, a lawnmower, an all terrain vehicle (ATV), a snow mobile, a motor home, a trailer, a camping trailer or a boat.

34. The method of claim 29, wherein the object-icon is an architectural structure or a vehicle.

35. The method of claim 34, wherein the vehicle is an automobile, a truck, a sport utility vehicle (SUV), a tractor, a lawnmower, an all terrain vehicle (ATV), a snow mobile, a motor home, a trailer, a camping trailer or a boat.

36. The method of claim 29, wherein the architectural structure is a home, a barn, a garage, an addition or a building.

37. A computer readable medium containing executable computer program instructions, which when executed by a data processing system, cause the data processing system to perform a method comprising:
displaying an object-icon on an information display, wherein the object-icon visually resembles something of interest to a user;
associating an information content with the object-icon, such that when the object-icon is selected, the information content is accessible to the user; and
relating a first part of the object-icon with a first unit of information, wherein the first unit of information is part of the information content.

38. The computer readable medium, as set forth in claim 37, the method further comprising:
selecting the first part, wherein the selecting makes first the unit of information accessible to the user.

39. The computer readable medium, as set forth in claim 37, the method further comprising:
selecting a second part of the object-icon, wherein the selecting makes a second unit of information accessible to the user and the second unit of information is part of the information content.

40. The computer readable medium, as set forth in claim 37, wherein the information content is related to an architectural structure or a vehicle owned by the user.

41. The computer readable medium, as set forth in claim 40, wherein the vehicle is an automobile, a truck, a sport utility vehicle (SUV), a tractor, a lawnmower, an all terrain vehicle (ATV), a snow mobile, a motor home, a trailer, a camping trailer or a boat.

42. The computer readable medium, as set forth in claim 37, wherein the architectural structure is a home, a barn, a garage, an addition or a building.

43. An apparatus comprising:
a means for displaying an object-icon;
a means for associating an object-icon with an information content; and
a means for relating a first part of the object-icon with a first unit of information from the information content.

44. The apparatus of claim 43, further comprising:
means for selecting the first part to make the first unit of information accessible to the user.

45. The apparatus of claim 43, further comprising:
means for selecting a second part of the object-icon to make a second unit of information accessible to the user and the second unit of information is part of the information content.

46. The apparatus of claim 43, wherein the information content is related to an architectural structure or a vehicle owned by the user.

47. The apparatus of claim 46, wherein the vehicle is an automobile, a truck, a sport utility vehicle (SUV), a tractor, a lawnmower, an all terrain vehicle (ATV), a snow mobile, a motor home, a trailer, a camping trailer or a boat.

48. The apparatus of claim 43, wherein the architectural structure is a home, a barn, a garage, an addition or a building.

49. The apparatus of claim 43, further comprising:
a means for creating a template.

50. The apparatus of claim 43, further comprising:
a means for creating a communication.

51. A method comprising:
constructing a user interface for a data management system, wherein the user interface contains a representation of an architectural structure and the architectural structure is designed utilizing a principle selected from the group consisting of a means for configuring a main entrance, a means for placing a vehicle parking space, a means for creating an entrance room, a means for configuring a kitchen, a means for providing outside light to a room, a means for situating a fire within the architectural structure, a means for creating an eating atmosphere, a means for creating a cooking layout, a means for varying the intimacy of a space, a means for sizing a window area, a means for differentiating a view, a means for locating a door to a room, a means for creating texture within a wall, a means for varying window size, a means for configuring window operation, a means for configuring a door, a means for configuring a window, a means for creating a private domain associated with the architectural structure, a means for positioning flowers, a means for positioning paving stones, and a means for creating a pool of light.

52. The method of claim 51, further comprising:
a means for composing an error message, wherein the error message is communicated to the user.

53. The method of claim 51, further comprising:
a means for regulating pleasure producing experiences derived by using the user interface.

54. The method of claim 51, further comprising:
a means for savoring an experience derived from using the user interface.

55. The method of claim 51, further comprising:
a means for providing a variable complexity to the operation of the user interface.

56. The method of claim 51, further comprising:
selecting a level of operational complexity for the user interface.

57. The method of claim 56, wherein the selecting is user selectable.

58. The method of claim 56, wherein the selecting is determined based on the user's interaction with the interface.

59. The method of claim 51, further comprising:
providing an error message that has a variable harshness in response to a wrong action by the user.

60. The method of claim 51, further comprising:
regulating the display of pleasure producing aspects of the user interface.

61. The method of claim 51, further comprising:
sharing a positive experience with another, wherein the experience is related to utilizing the user interface.

62. The method of claim 51, further comprising:
providing a congratulatory message to the user in response to an action by the user.

63. A computer readable medium containing executable computer program instructions, which when executed by a data processing system, cause the data processing system to perform a method comprising:
constructing a user interface for a data management system, wherein the user interface contains a representation of an architectural structure and the architectural structure is designed utilizing a principle selected from the group consisting of a means for configuring a main entrance, a means for placing a vehicle parking space, a means for creating an entrance room, a means for configuring a kitchen, a means for providing outside light to a room, a means for situating a fire within the architectural structure, a means for creating an eating atmosphere, a means for creating a cooking layout, a means for varying the intimacy of a space, a means for sizing a window area, a means for differentiating a view, a means for locating a door to a room, a means for creating texture within a wall, a means for varying window size, a means for configuring window operation, a means for configuring a door, a means for configuring a window, a means for creating a private domain associated with the architectural structure, a means for positioning flowers, a means for positioning paving stones, and a means for creating a pool of light.

64. The computer readable medium, as set forth in claim 63, the method further comprising:
selecting a level of operational complexity for the user interface.

65. The computer readable medium, as set forth in claim 63, the method further comprising:
regulating the display of pleasure producing aspects of the user interface.
